(19) United States
(12) Patent Application Publication
(10) Pub. No.: US 2013/0132809 A1
(43) Pub. Date: May 23, 2013

(54) STRUCTURE AND METHOD FOR WIDGET PERSONALIZATION AND WIDGET INTERACTION

(71) Applicants: CHIEN-CHAO TSENG, HSINCHU CITY (TW); YU-HUA LU, HSINCHU COUNTY (TW); CHENG-YUAN HO, TAIPEI CITY (TW); YU-CHIEN HUANG, CHANGHUA COUNTY (TW)

(72) Inventors: CHIEN-CHAO TSENG, HSINCHU CITY (TW); YU-HUA LU, HSINCHU COUNTY (TW); CHENG-YUAN HO, TAIPEI CITY (TW); YU-CHIEN HUANG, CHANGHUA COUNTY (TW)

(73) Assignee: NATIONAL CHIAO TUNG UNIVERSITY, HSINCHU CITY (TW)

(21) Appl. No.: 13/424,654

(22) Filed: Mar. 20, 2012

(30) Foreign Application Priority Data
Nov. 22, 2011 (TW) 100142763

(51) Int. Cl. G06F 17/00

(52) U.S. Cl. 715/205

(57) ABSTRACT

The present invention provides a structure and method for widget personalization and widget interaction, wherein user preference keys and user preference values are generated according to user profiles and binding configurations of a plurality of widgets, and wherein the keys and values of a widget are added to URL of the widget, whereby a personalized widget is attained after the widget is reloaded. The setting data of a widget, including a plurality of element values, are stored in a document object model (DOM). When relativities exist between widgets, the related element values are transferred from one widget to other widgets through a transfer module to replace the element values in DOM of the other widgets and update the other widgets.

### BACKGROUND OF THE INVENTION

1. Field of the Invention

The present invention relates to a website personalization and interaction technology, particularly to a structure and method for widget personalization and widget interaction.

2. Description the Related Art

A widget or gadget is a small application program executable in an HTML webpage. A widget may be directed to videos, maps, news or games. In the widget technology, the user preference is an attribute to provide personal data. For example, in Google, the user preference is defined in the XML syntax of the Google application programs. The user preference is composed of a pair of key and setting value. The setting values of some user preferences can be directly assigned by the user. The fields where the user input data are programmed in the user preference block of the source code of the widget before the widget is compiled.

The widget container provides the user interface and stores all settings. The application server stores a plurality of widgets. The widget server is responsible for compiling the widgets. When the widget container asks for a widget from the application server via the widget server, the address of the source file, the key and setting value of the user preference must be substituted into URL (Universal Resource Locator). Thereby, the widget server can obtain the settings of the widget according to the abovementioned parameters and then determine the result of widget compiling.

In the current technology, the default value of a user preference of a widget is normally determined by the developer. For example, the default value of the searched position of the Google map is San Francisco. When the user uses the widget of the Google map, the map presented on the webpage is preset to center at San Francisco. The default value of the searched position of the Google weather prediction is Hong Kong. Thus, the weather prediction presented on the webpage is preset to predict the weather of Hong Kong. Besides, the personalization of the widgets cannot be completed in a single process but must be set one by one manually. For example, the user must personalize the default value in the Google map once, and then personalize the default value once again in the Google weather prediction. Further, the personalized widget cannot be presented unless the widget is reloaded or the webpage is renewed.

Currently, the interaction mechanisms of widgets are stressed on defining API (Application Programming Interface). The interaction mechanisms of widgets are embedded in the source codes. When a third party designs a new widget, he cannot enable the new widget to interact with old widgets unless the original developer amends the source codes of all the widgets. Further, since the interaction mechanisms of widgets have been defined during the development thereof, users cannot personalize them according to their own preferences. Besides, cross-platform application of widgets is impossible in the conventional widget technology.

Accordingly, the present invention proposes a structure and method for widget personalization and widget interaction to overcome the abovementioned problems. The principle and embodiments of the present invention are to be described in detail below.

### SUMMARY OF THE INVENTION

The primary objective of the present invention is to provide a structure and method for widget personalization and widget interaction, wherein the widget container stores the user profiles and the binding configurations of the user, wherein when the widget container asks the widget server to compile a widget, the widget container uses the user profiles and the binding configurations to generate user preference keys and user preference values and adds the user preference keys and the user preference values to URL of the widget to personalize the widget, whereby the user is exempted from inputting user profiles to different widgets one by one.

Another objective of the present invention is to provide a structure and method for widget personalization and widget interaction, wherein widget interfaces are respectively established for widgets, and wherein the sharable data is built in a document object model, and wherein the program code is dynamically inserted into the compiled widget according to the relativities of widgets, whereby once the setting of a widget is varied, the settings of the related widgets are also updated, wherefore the user is exempted from modifying the settings of widgets one by one and enjoys more convenience in using widgets.

To achieve the abovementioned objectives, the present invention proposes a structure for widget personalization and widget interaction, which comprises an application server, a widget server, a widget container, at least one user preference input interface, and a transfer module. The application server contains a plurality of widgets. The widget server uses the original URL of a widget to ask for the widget from the application server. The widget container includes a user profile module storing user profiles and a binding configuration module storing the inter-widget binding configurations and the widget-user binding configurations. The user preference input interfaces are respectively corresponding to the widgets and linked to the user profile module to establish the relativities of the user profiles and the user preferences. The transfer module is arranged inside the widget container. The transfer module uses the relativities to link the content input interfaces and content output interfaces of widgets or link the user preference input interfaces and content output interfaces of widgets. The transfer module receives settings of one widget and transfers the settings to another widget.

The present invention also proposes a widget personalization method, which comprises steps: an application server storing a plurality of widgets, a widget container storing user profiles and binding configurations, and a widget server using URL of the source file of a widget to ask for the widget; the widget container generating at least one user preference key and at least one user preference value according to the user profiles and said binding configurations; when asking for compiling a widget, the widget container adding a pair of user preference key and user preference value, which are corresponding to the widget, to URL of the widget to for a new URL; and the widget server acquiring the user preference key and the user preference value from the new URL, and generating a personalized widget.

The present invention further proposes an interaction method for personalized widgets, which comprises steps: establishing widget interfaces for widgets, wherein each widget interface contains the setting data of the widget and includes an input module and an output module; establishing relativities of widgets, and using a transfer module to link content output interfaces with content input interfaces of related widgets or link content output interfaces with user preference input interfaces of related widgets; the output module using the content output interface to transfer the setting data of a widget to the transfer module, another widget using the content input interface to receive the setting data from the output module or receive the setting data from the user preference input interface, and writing the setting data into URL of the another widget to update the setting data of the another widget.

Below, the embodiments are described in detail to make easily understood the objectives, technical contents, characteristics and accomplishments of the present invention.

### BRIEF DESCRIPTION OF THE DRAWINGS

FIG. 1A is a block diagram schematically showing a structure for widget personalization and widget interaction according to one embodiment of the present invention;

FIG. 1B schematically shows a widget interface according to one embodiment of the present invention;

FIG. 2 shows a flowchart of a widget personalization method according to one embodiment of the present invention;

FIG. 3A and FIG. 3B are diagrams schematically showing constitutions of personalized widgets according to one embodiment of the present invention;

FIG. 4 schematically shows an embodiment of a personalized widget according to the present invention;

FIG. 5A and FIG. 5B schematically show relativity-based interaction of widgets according to one embodiment of the present invention;

FIG. 6 schematically shows that a transfer module implements linkage of widgets according to one embodiment of the present invention;

FIG. 7 shows a flowchart of a widget interaction method according to one embodiment of the present invention; and

FIG. 8 schematically shows an embodiment of widget interaction according to the present invention.

### DETAILED DESCRIPTION OF THE INVENTION

The present invention proposes a structure and method for widget personalization and widget interaction, which detects user profiles and establishes the relativity between widget contents and user profiles, whereby to simplify widget personalization. Further, the present invention defines a widget interface enabling external communication and intercommunication of widgets.

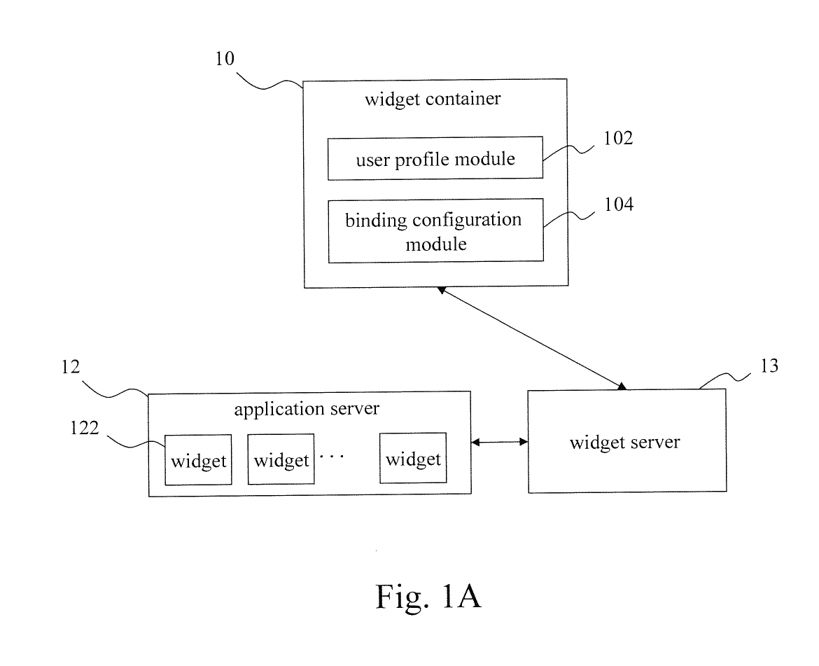

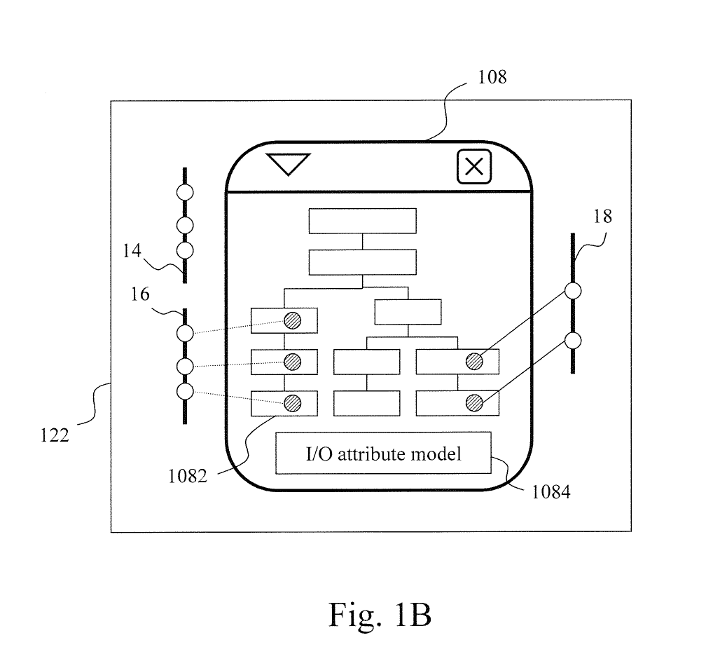

Refer to FIG. 1A a block diagram schematically showing a structure for widget personalization and widget interaction according to one embodiment of the present invention. The structure of the present invention comprises a widget container 10, an application server 12 and a widget server 13. The application server 12 contains a plurality of widgets 122, such as the map widget, weather prediction widget, calendar widget, clock widget, etc. The widget server 13 uses URL of a widget to ask for the widget and then compiles the widget. The widget container 10 includes a user profile module 102 and a binding configuration module 104. The user profile includes the name, account number, country and time zone of the user and also includes the webpage layout, font and font size, which are preferred by the user. The binding configurations include the relativity between different widgets 122 and the relativity between a widget 122 and a user. For example, the map widget and the weather prediction widget are associated with the country and residence address of the user.

Refer to FIG. 1B for the structure of a widget having been compiled by the widget server. Each compiled widget 122 comprises a widget interface 108. The widget interface 108 implements external communication of the widget 122. The user can use the widget interface 108 to assign the sharable data stored inside the widget 122. The widget interface 108 includes a document object model (DOM) 1082 and an I/O (Input/Output) attribute model 1084. The document object model 1082 is an application programming interface (API) used by HTML and XML documents and providing structures for documents. The document object model 1082 has a plurality of elements and the value types thereof. The designer can vary the elements and the value types to modify the contents a widget and the way to present the widget. The I/O attribute module 1084 contains names and message types respectively corresponding to the elements and the value types. The compiled widget 122 also comprises a user preference input interface 14, a content input interface 16 and a content output interface 18. Each user preference input interface 14 is associated with one widget 122 and linked with the user profile module 102 to establish the relativity between the user profile and the user preference. The content output interface 18 acquires the element values from the document object model of the widget and outputs the element values to the other widgets 122. The content input interface 16 receives the information of interaction and inputs the element values to the elements of the document object model 1082. Then, the widget 122 is triggered to change the contents thereof. For example, the widget 122 is reset to update the contents thereof.

Both the content input interface 16 and the user preference input interface 14 are responsible for receiving information of interaction. However, the content input interface 16 inputs the received element values to the document object model 1082, and the user preference input interface 14 inputs the received keys and setting values to URL of the widget.

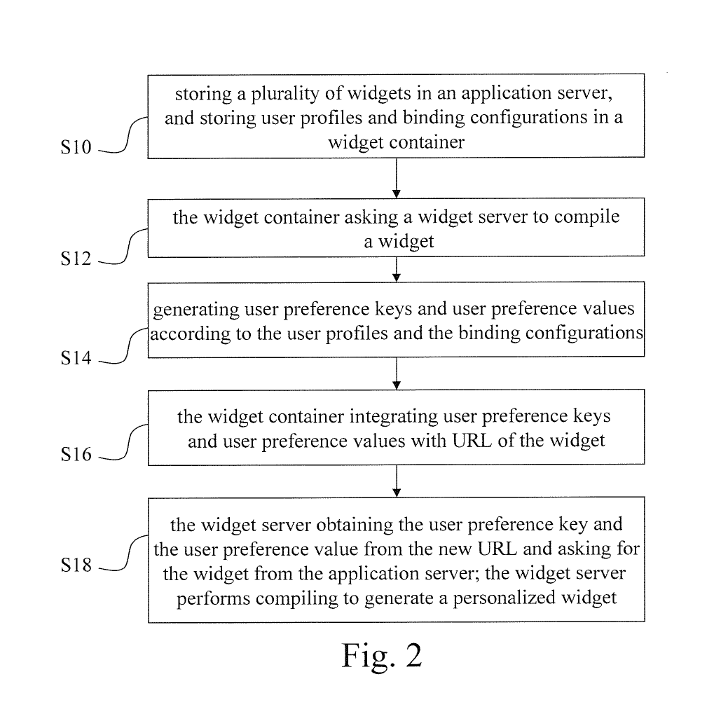

Refer to FIG. 2 for a flowchart of a widget personalization method according to one embodiment of the present invention. The widget personalization method of the present invention is to personalize the user preferences, which are originally preset by the designers of the widgets. In step S10, a plurality of widgets is stored in an application server; user profiles and binding configurations are stored in a widget container. In step S12, the widget container asks a widget server to compile a widget. In step S14 the widget container generates at least one user preference key and at least one user preference value according to the user profiles and the binding configurations. In step S16, the widget container integrates a pair of user preference key and user preference value, which are corresponding to a widget, with URL of the widget. For example, the widget container adds the user preference key and the user preference value to the end of URL in form of a bit string or a byte string to generate a new URL and then transfers the new URL to the widget server. In step S18, the widget server obtains the user preference key and the user preference value from the new URL and asks the application server to provide information of the widget; then the widget server performs compiling to generate a profile-aware widget.

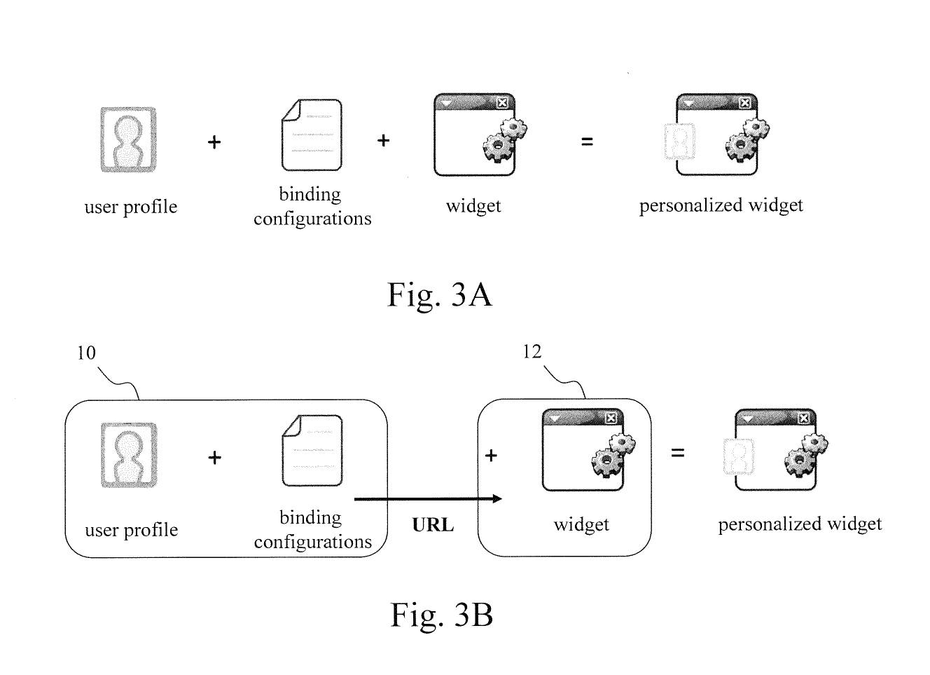

Refer to FIG. 3A showing that a user profile, a binding configuration and a widget are integrated to form a personalized widget. Refer to FIG. 3B. The user profile and binding configuration are stored in the widget container 10. The widget is stored in the application server 12. The widget container 10 generates a user preference key and a user preference value according to the user profile and the binding configuration. When asking the widget server 13 to compile the widget, the user container 10 transfers the user preference key and the user preference value to the widget server 13 via appending the user preference key and the user preference value to the end of URL. The widget server 13 compiles the widget according to the user preference key and the user preference value to form a personalized widget.

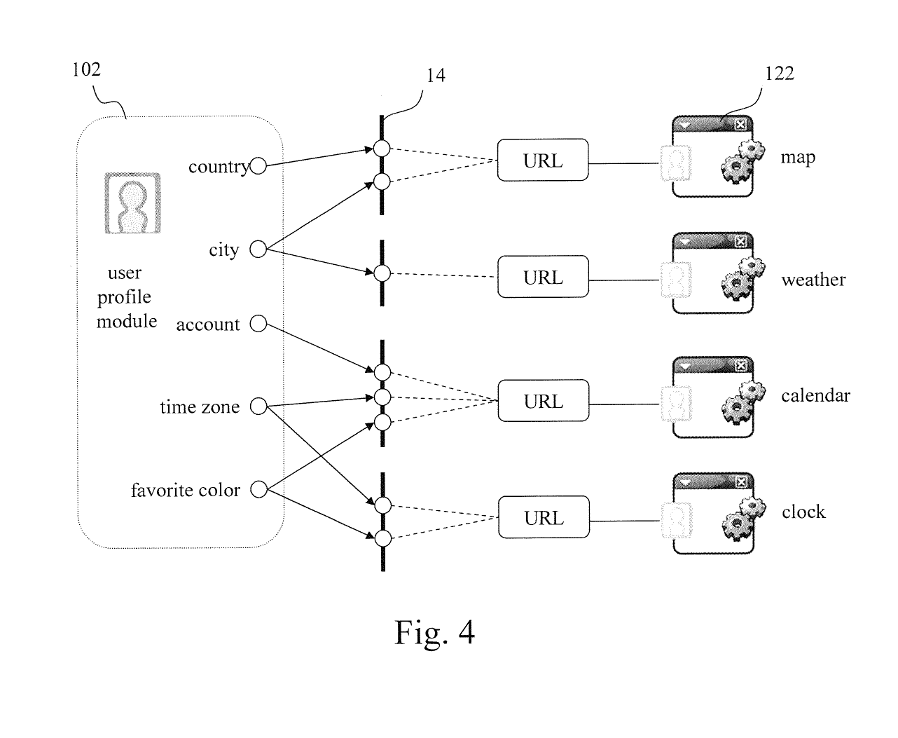

The user preference input interface 14 shown in FIG. 1B represents a personalization interface of a widget 122. The user preference input interface 14 can be used to affect the result of widget compiling. The user preference input interface 14 associates the user preference with the user profile. Suppose that the user preference of a given widget 122 refers to a user profile. When the user varies the contents of the user profile thereof, the user preference of the given widget 122 is also varied. Refer to FIG. 4 a diagram schematically showing how the user preference input interface 14 associates a user profile with widgets 122. In FIG. 4, there are four widgets 122, including a map widget, a weather widget, a calendar widget and a clock widget. The user preferences of the four widgets 122 include country, city, time zone, account number, and favorite color. Each widget 122 has its own URL. Via the user preference input interface 14, the user preference keys and user preference values related to a widget 122 are added to URL of the widget 122. For example, the user preference keys related to the map widget 122 include keys of country and city. The user preference values related to the map widget 122 are a specified country and a specified city, such as Taiwan and Taipei. Suppose that the map is preset to center at Chicago, USA. After the user preference keys and user preference values have been received, the central point of the map widget is changed to be Taipei, Taiwan. Further, the user preference keys and user preference values are added to the original URL of the map widget to generate a new URL. Hereafter, when the map widget is triggered, the presented map is always centered at Taipei, Taiwan every time.

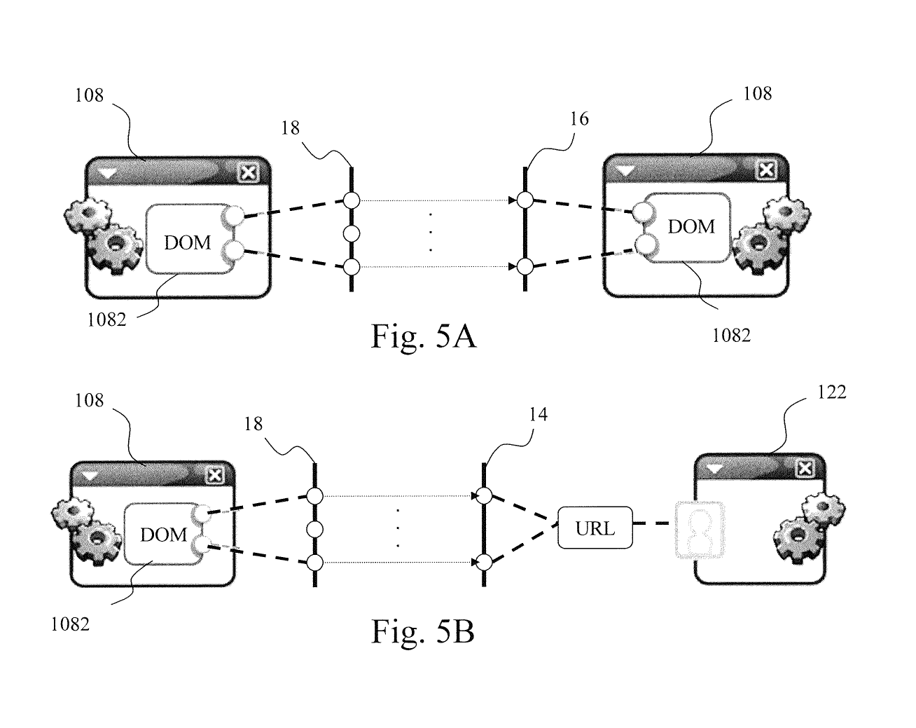

When the user profile is varied, the widget personalization method of the present invention can synchronously update the user preferences of all the widgets using the same user profile. A widget interface is further needed to synchronously update relativity of widgets and enable interaction of widgets. Refer to FIG. 5A and FIG. 5B. In FIG. 5A, the content output interface 18 obtains the element values from the document object model 1082 of the widget in the left and then transfers the element values to the content input interface 16 of the widget in the right. Then, the content input interface 16 inputs the element values to the document object model 1082 of the widget in the right. In FIG. 5B, the content output interface 18 obtains the element values from the document object model 1082 of the widget in the left. As the widget 122 does not have a content input interface, the user preference input interface 14 regards the element values as the user preference keys and user preference values and adds them to URL of the widget.

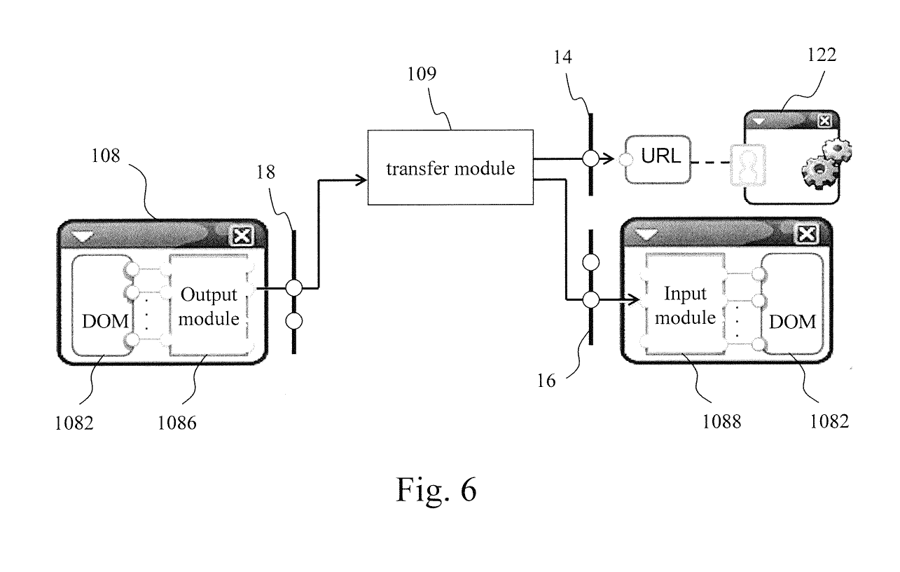

Refer to FIG. 6 a diagram schematically showing a widget interaction structure according to one embodiment of the present invention. As widgets are embedded in webpages in form of IFrame, they cannot intercommunicate. Therefore, the present invention establishes a transfer module 109 in the widget container to transfer information. Further, the present invention establishes an output module 1086 and an input module 1088 in each widget interface. The output module 1086 obtains corresponding element values from the document object model 1082 and sends the element values to the transfer module 109 via the content output interface 18. The input module 1088 uses the content input interface 16 to obtain the element values recently received by the transfer module 109 and adds the element values to the corresponding elements in the document object model 1082. Then, an event is triggered to update the contents of the widget. If a widget 122 has no content input interface, the widget 122 obtains the element values received by the transfer module 109 via the user preference input interface 14 and then adds the element values to URL of the widget 122.

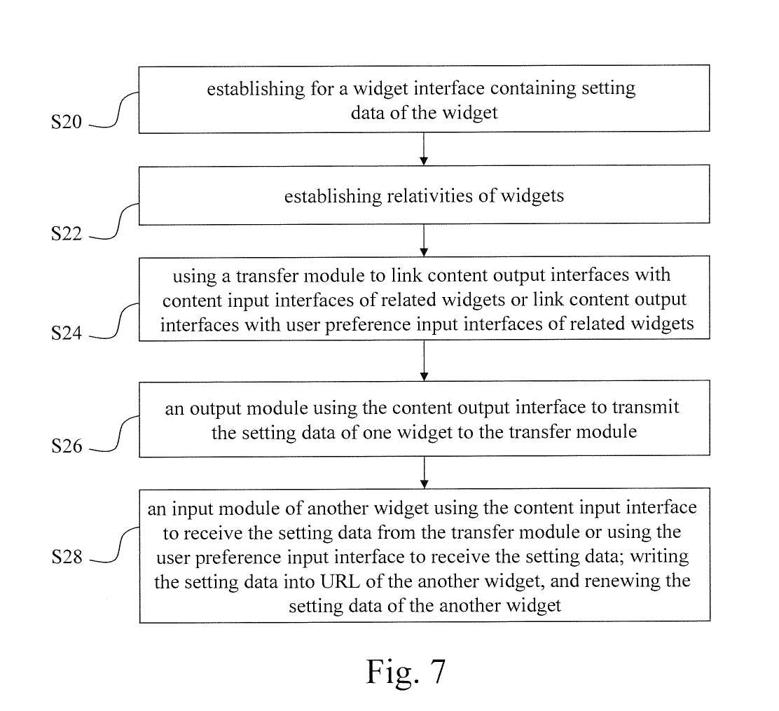

Refer to FIG. 7 for a flowchart of a widget interaction method according to one embodiment of the present invention. In Step S20, a widget interface is set up. The widget interface contains the setting data of the widget, such as the elements of the document object model and the I/O attributes. Each widget interface also contains an input module and an output module, which are used to communicate with other widget interfaces. In Step S22, the relativity of widgets is set up. In Step S24, the transfer module links the content output interface and the content input interface/user preference input interface of the related widget. When the widgets intend to interact, the process proceeds to Step S26. In Step S26, the output module of one widget sends the setting data of a widget to the transfer module via the content output interface. In Step S28, the content input interface of another widget receives the setting data from the input module; alternatively, the setting data is received by the user preference input interface and written into URL; then the setting data of the another widget is updated.

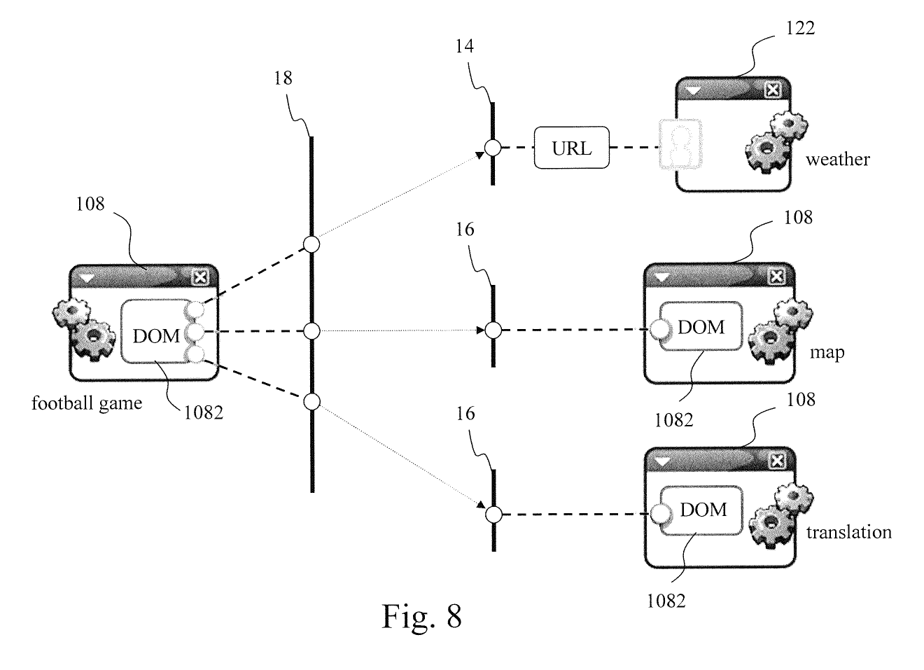

Refer to FIG. 8 for an embodiment of widget interaction. Suppose that a football game widget provides football game-related information. A user operating interface is used to set up the document object model 1082 and the I/O attribute module 1084 and establish the content output interfaces 18 of “football field”, “football news”, and “host city”. Relativities are respectively established between the three the content output interfaces 18 and the user preference input interface 14/the content input interfaces 16 of a weather prediction widget, a map widget, and a translation widget. The football field is sent to the content input interface 16 of the map widget so as to present the exact position of the football field. The host city is sent to the user preference input interface 14 of the weather prediction widget and written into URL of the weather prediction widget so as to predict the weather of the host city. The football news is sent to the content input interface 16 of the translation widget so as to translate the football news into the language the user prefers.

In conclusion, the present invention stores the user profiles and binding configurations in a widget container; when the widget container asks a widget server to compile a widget, the widget container uses the user profile and binding configuration to generate a user preference key and a user preference value and transfers the user preference key and the user preference value to the widget server; the widget server obtains the user preference key and the user preference value with the original URL and asks for the widget from an application server to personalize the widget. Further, the present invention respectively establishes widget interfaces for document object models and stores sharable data in the document object models. According to the interactive relationships, the present invention dynamically inserts program codes into the compiled widgets. Thereby, when the settings of one widget are varied, the settings of the related widgets are also automatically varied. Therefore, the user needn't vary the settings of all the related widgets one by one manually and thus enjoys more convenience in using widgets.

The embodiments described above are only to exemplify the present invention but not to limit the scope of the present invention. Any equivalent modification or variation according to the characteristics or spirit of the present invention is to be also included within the scope of the present invention.

What is claimed is:

1. A structure for widget personalization and widget interaction, comprising
an application server containing a plurality of widgets;
a widget server using URLs (Universal Resource Locator) of source files of said widgets to ask for said widgets from said application server, and compiling said widgets;
a widget container including a user profile module storing a plurality of user profiles and a binding configuration module storing a plurality of inter-widget binding configurations and a plurality of user-widget binding configurations;
at least one user preference input interface each corresponding to one said widget, linked to said user profile module, and establishing relativities of said user profiles and a plurality of user preferences; and
a transfer module arranged inside said widget container, using said relativities to link a content input interface of one widget with a content output interface of another widget related to said widget, or link said user preference input interface of one widget with a content output interface of another widget related to said widget, receiving setting data of one widget, and transferring said setting data to another widget related to said widget.

2. The structure for widget personalization and widget interaction according to claim 1, wherein said widget container generates at least one user preference key and at least one user preference value according to said user profiles and said binding configurations.

3. The structure for widget personalization and widget interaction according to claim 2, wherein said widget container generates a pair of said user preference key and said user preference value, which are corresponding to one widget, and wherein said widget container integrates said user preference key and said user preference value with URL of said widget to form a new URL, and wherein said widget container transmits said new URL to said widget server, and wherein said widget server obtains said user preference key and said user preference value from said new URL to generate a new widget.

4. The structure for widget personalization and widget interaction according to claim 3, wherein a count of said user preference keys or said user preference values, which are integrated with said URL, is equal to a count of said user profiles to be modified.

5. The structure for widget personalization and widget interaction according to claim 1, wherein each said widget has a widget interface, and wherein said widget interface contains setting data of said widget, and wherein said widget interface further has an input module and an output module.

6. The structure for widget personalization and widget interaction according to claim 1, wherein said setting data includes a document object model (DOM) and an I/O attribute module.

7. The structure for widget personalization and widget interaction according to claim 6, wherein said content output interface retrieves values from said document object model of said widget and sends out said values.

8. The structure for widget personalization and widget interaction according to claim 6, wherein said I/O attribute module contains names and message types, and wherein said document object model contains a plurality of elements and values types thereof, and wherein said names in said I/O attribute module are respectively corresponding to said elements in said document object model, and wherein said message types are respectively corresponding to said value types.

9. A widget personalization method comprising steps:
storing a plurality of user profiles and a plurality of binding configurations in a widget container;
generating at least one pair of user preference key and user preference value according to said user profiles and said binding configurations;
when asking for compiling a widget, said widget container generating a pair of user preference key and user preference value, which are corresponding to said widget, and integrating said user preference key and said user preference value with URL of said widget to form a new URL; and
a widget server acquiring said user preference key and said user preference value according to said new URL, asking for said widget, which is to be compiled, from an application server, and generating a personalized widget.

10. The widget personalization method according to claim 9, wherein a count of said user preference keys or said user preference values, which are integrated with said URL of said widget, is equal to a count of user preferences to be modified, whereby is formed said personalized widget having said new URL.

11. The widget personalization method according to claim 10, wherein a user preference input interface is used to add said user preference keys and said user preference values to said URL, and wherein when said widget is reloaded, said personalized widget is presented.

12. The widget personalization method according to claim 11 further comprising a step of establishing a links between said user profile and said user preference input interface, and using said user preference input interface to establish relativities between said user profile and said user preferences.

13. The widget personalization method according to claim 12, wherein if said user profile is revised, said user preferences of said widgets whose user preferences refer to said user profile are also revised.

14. An interaction method for personalized widgets, comprising steps:
establishing widget interfaces for a plurality of widgets, wherein said widget interface of a widget has setting data of said widget and includes at least one input module and at least one output module;
establishing relativities of said widgets, and using a transfer module to link content output interfaces with content input interfaces of related widgets or link content output interfaces with user preference input interfaces of related widgets; and
said output module using said content output interface to transmit said setting data of one said widget to said transfer module; another said widget using said content input interface to receive said setting data from said input module or using said user preference input interface to receive said setting data; writing said setting data into URL of said another said widget, and updating said setting data of said another said widget.

15. The interaction method for personalized widgets according to claim 14, wherein said setting data includes a document object model and an I/O attribute module.

16. The interaction method for personalized widgets according to claim 15, wherein said content output interface is used to retrieve values of said document object models of said widgets and then output said values.

17. The interaction method for personalized widgets according to claim 16, wherein said content input interface of another widget receives said values output by said content output interface and adds said values into said document object model, and wherein said user preference input interface adds said values to URL of said widget.

18. The interaction method for personalized widgets according to claim 15, wherein said I/O attribute module contains names and message types, and wherein said document object model contains a plurality of elements and values types thereof, and wherein said names in said I/O attribute module are respectively corresponding to said elements in said document object model, and wherein said message types are respectively corresponding to said value types.
